(19) United States
(12) Patent Application Publication
(10) Pub. No.: US 2025/0383535 A1
(43) Pub. Date: Dec. 18, 2025

(54) OPTICAL SECTIONING AND SUPER-RESOLUTION IMAGING IN TDI-BASED CONTINUOUS LINE SCANNING MICROSCOPY

(71) Applicant: Miltenyi Biotec, Inc., Gaithersburg, MD (US)

(72) Inventors: Robin DIEKMANN, Bergisch Gladbach (DE); Heinrich SPIECKER, Bergisch Gladbach (DE); Chris NEHME, Bergisch Gladbach (DE); Hansueli MEYER, 1201 Clopper Road, MD (US)

(73) Assignee: Miltenyi Biotec, Inc., Gaithersburg, MD (US)

(21) Appl. No.: 18/879,196

(22) PCT Filed: Jun. 27, 2023
(86) PCT No.: PCT/US2023/026294

§ 371 Date: Dec. 26, 2024

Related U.S. Application Data
(60) Provisional application No. 63/357,733, filed on Jul. 1, 2022.

(51) Int. Cl. G02B 21/00; G01N 21/64; G02B 27/58

(52) U.S. Cl. CPC G02B 21/008; G02B 21/004; G02B 21/0056; G02B 21/0076; G02B 27/58; G01N 21/6458

(57) ABSTRACT

An imaging system for imaging a biological sample or another sample containing fluorescent molecules may include an optical system with a light source emitting light, wherein the light is directed by the optical system to the sample via at least one plane being conjugate to the image plane. The optical source may have an extended radiation pattern, in other words, the radiation beam may have an extent in the x- and y-planes, rather than a point source. The extent of the illumination region in x and y may be based on and matched to the detector area onto which the radiation may be imaged, preferably a TDI detector. This novel system may include genomics, proteomics and transcriptomics work flows.

### CROSS REFERENCE TO RELATED APPLICATIONS

This US non-Provisional Patent Application claims priority to US Provisional Application Ser. No. to 63/357,733 ('733 application), filed Jul. 1, 2022. The '733 application is incorporated by reference in its entirety.

### STATEMENT REGARDING FEDERALLY SPONSORED RESEARCH

Not applicable.

### STATEMENT REGARDING MICROFICHE APPENDIX

Not applicable.

### BACKGROUND

The present invention relates to time delayed integration (TDI) microscopy for optical imaging of biological samples.

A continuous line scanning microscope based on time-delayed-integration (TDI) camera detection offers significantly higher throughput compared to traditional stop-and-stare approaches. The TDI-based detection is therefore a favorable candidate for various existing imaging systems, as well as for the next generation biological imaging systems, where additional optical sectioning and ability to image volume samples such as tissue sections, organoids or whole organs are highly desired. Though optical sectioning can be introduced by illumination with a single diffraction-limited point focus or line focus, this approach comes with many disadvantages since expensive and bulky laser instrumentation is required and scanning speed is either restricted by low fluorescence, luminescence, or phosphorescence signal from the small illuminated area, and/or local intensities have to be extremely high, potentially leading to sample damage.

### SUMMARY OF THE INVENTION

To overcome the illumination issue for optical sectioning while still maintaining the advantages of TDI-based detection, described here is a multi-slit or multi-pinhole illumination/detection combination that permits the use of widefield fluorescence excitation. Additionally, this approach allows for background subtraction strategies.

A mask (e.g. a plurality of transmissive and reflective features arranged in an array) is inserted into an intermediate image plane or a plane conjugate to the microscope image plane where the sample is located. The sample is illuminated through this grid, leading to structured illumination in the focal plane. Light detection through the same grid leads to efficient optical sectioning since mainly the light from in-focus radiation is transmitted through the grid and out-of-focus light is reflected by the non-transmissive regions of the mask. In this system described here, the TDI-based line scanning microscope, where the sample is the only mechanically moving part, the mask is statically positioned in the intermediate image plane. However, the illumination is moved relative to the sample since the sample itself is scanned and light detection effectively follows through the TDI-process of the camera.

This concept efficiently combines throughput and multi-color capability, since it allows for simultaneous, yet spatially separated illumination and detection of multiple color channels. Lines for illumination are located side-by-side at the sample and a particular color-channel is detected only from the region where its intended excitation is located. Hence, multi-color imaging at suppressed cross-talk is easily implemented without the need for time-consuming iterative imaging of the same field-of-view. This advantage of the proposed concept makes it favorable over other optical sectioning strategies.

Employing a partially transmissive and partially reflective mask additionally permits the imaging of the out-of-focus signal by another detector. Simultaneous recording of the in-focus and out-of-focus signal can be used for computational enhancement of the optical sectioning. This approach features the huge benefit that a flat mask may be used, so the blazed-grating effect does not occur.

The mask itself is standing still, overcoming the need for an element that is rotating or translating during the image formation process which might be error prone due to induced vibrations or actuator failure.

Alternatively, a digital micromirror device can be implemented as a mask using the on-state pixels for generation of structured illumination and filtering of in-focus signal and the off-state pixels for filtering of out-of-focus signal while taking the blazed grating effect into account in the optical system design.

Accordingly, described here is an imaging system for imaging a biological sample or another sample containing fluorescent molecules. The system may include an optical system with a light source emitting light, wherein the light is directed by the optical system to the sample via at least one plane being conjugate to the image plane, at least one mask disposed adjacent to a plane conjugate to the image plane, wherein the at least one mask comprises regions that transmit-the light and regions that reflect-the light. The system may also include at least one first detector that detects light from the sample transmitted through the at least one mask, and at least one second detector that detects light from the sample reflected by the at least one mask. The system may also include a moving stage configured to continuously move the sample during detection by the first and second detectors, and an image processing controller, programmed to form a corrected image based on both the transmitted and the reflected light from the continuously moving sample.

### BRIEF DESCRIPTION OF THE DRAWINGS

Various exemplary details are described with reference to the accompanying drawings which should not be taken to limit the invention to the specific embodiments shown but are for explanation and understanding only.

FIG. 1 is a simplified schematic illustration of a first exemplary optical layout 10 of the optical sectioning microscope using TDI-based continuous line scanning;

FIG. 2 is a simplified schematic illustration of the signal generation in a TDI camera-based imaging system;

FIG. 3 shows detail of an exemplary embodiment of a partially reflective/partially transmissive mask used in the TDI-based continuous line scanning;

FIG. 4 shows additional detail of a portion of a partially transmissive/partially reflective mask with changing slit widths transmissive and reflective regions, appropriate for simultaneous operation of different excitation and/or emission wavelengths of the fluorescent tags;

FIG. 5 shows additional detail of an exemplary layout of a partially transmissive/partially reflective mask showing the different regions appropriate for different fluorescent tags excited and emitting at different fluorescent wavelengths;

FIG. 6 is a simplified schematic illustration of a second exemplary optical layout 100 of the optical sectioning microscope using TDI-based continuous line scanning;

FIG. 7 is a simplified schematic illustration of a third exemplary optical layout 200 of the optical sectioning microscope using TDI-based continuous line scanning;

FIG. 8 is a simplified schematic illustration of a fourth exemplary optical layout 300 of the optical sectioning microscope using TDI-based continuous line scanning;

FIG. 9 is a simplified schematic illustration showing the shift of ½ pixel of two adjacent detector arrays, which can be used for resolution enhancement orthogonal to the stage movement direction;

FIG. 10 illustrates the application of the novel imaging system to a generic downstream workflow;

FIG. 11 illustrates further detail of the downstream workflow genetic sequencing methodology coupled to the novel optical sectioning imaging system; and

FIG. 12 is an exemplary flow chart of the work process with the DNA sequencing strategy.

It should be understood that the drawings are not necessarily to scale, and that like numbers maybe may refer to like features.

### DETAILED DESCRIPTION

The following description is directed to a system for an optical sectioning microscope using TDI-based continuous line scanning, and its operation. In the embodiments described below, the following reference numbers may be used to refer to specific components. In the alternative embodiments, these components performing similar functions may use similar numbers. For example, in each embodiment, 10, 100, 200 and 300, the moving stage that moves the sample continuously may be desginated 5, 105, 205, and 305.
5, 105, 205, 305 moving stage holding scanned sample
8, 108, 208, 308 objective lens
12, 112, 113, 212, 213, 312 tube lens
14 TDI camera for out-of-focus detection
150, 250, 350 light to TDI camera for out-of-focus detection installed downstream
24 TDI camera for in-focus detection
122, 222, 322 light to TDI camera for in-focus detection installed downstream
35 spectral filter
13 relay optics
20, 120, 220 partially reflective, partially transmissive mask
130 partially transmissive mask
26, 126, 226, 326 dichroic mirror
28 beam shaping optics including wavelength separating element
30, 130, 230, 330 radiation
40 radiation source
121, 221, 321 partially reflective mask containing microlens array
220 microlens array

In the discussion which follows, the term “conjugate plane” is used synonymously with “image plane”. “intermediate plane” and “conjugate focal image plane” to refer to the plane in which an optical element forms a non-magnified or magnified image of an object, such that the object and its image are interchangeable. An “intermediate image” refers to a pointwise image of a structure formed in the image plane by an optical system or an “intermediate image” refers to a pointwise image of a structure formed in a plane conjugate to the image plane by the optical system. A “tube lens” is a focusing element in a microscope positioned adjacent to the objective lens, which forms an intermediate image. An “Airy unit” is the wavelength-dependent diameter of the central peak of the Airy pattern. Generally, 1 Airy unit=0.61*wavelength*magnification/NA where NA=numerical aperture. “DAPI” is an acronym for (4′,6-diamidino-2-phenylindole) a blue-fluorescent DNA stain that exhibits ˜20-fold enhancement of fluorescence upon binding to AT regions of dsDNA. “Cy5” is a bright, far-red-fluorescent dye with excitation ideally suited for the 633 nm or 647 nm laser lines.

The techniques described here may be applicable to numerous sorts of biological samples and may be incorporated into variety of workflows. For example, the samples may comprise a tissue section and may be at least about 1 um thick. The sample and workflow may be configured for spatial proteomics, spatial transcriptomics and/or spatial genomics, for example. In these embodiments, the work flow may include staining of proteins using antibodies (proteomics), the staining messenger RNA (transcriptomics) and the staining of genetic material (genomics) in nucleus of a cell, for example. Additional details as to these workflows may be found in Patent Application serial numbers U.S. Pat. No. 301,115 filed Nov. 13, 2018, EP21180189.9 filed Jun. 18, 2021 and EP 21198504.9 filed Sep. 23, 2021, each of which is incorporated by reference in their entireties for all purposes. Using the microscope described here would provide additional information as to the location of the stained structure. Sequencing of spatially located structure may also be performed by repeated staining and sequencing of the DNA and RNA. For example, to spatially locate 6 amino acids may require the six times repeated steps of staining, imaging and restaining.

The embodiments generally include a radiation source, an objective lens, a moving sample stage, at least one TDI camera, and at least one partially reflective and partially transmitting mask. The TDI camera may be operated so as to be synchronized with the movement of the sample on the moving sample stage. Several embodiments are described and others are envisioned, using various combinations of the above components, or additional components, and these embodiments are described fully below.

In the embodiments described below, the partially reflective/partially transmissive mask may have transmissive regions that allow light to pass as well as reflective regions that may be opaque, or reflective. Thus, the transmissive regions may be voids or apertures or lenses or cylindrical lenses, or they may comprise a transparent, transmissive material.

Transmissive regions allow the light to pass through along a transmissive trajectory, and the light may then be focused by a first imaging system.

In some embodiments, reflective regions may reflect the light from the mask into the reflected trajectory. The reflective regions may be a reflective material or a reflective coating on a supporting surface. The reflected light on the reflected trajectory may be focused by additional optical elements into a second imaging system.

Various shapes may be used for the transmissive and reflective regions in the mask. For example, the regions that transmit light may be an array of rectilinear apertures or two dimensional (2D) symmetric apertures, wherein the apertures may comprise slots, slits or pinholes in the mask that transmit the light and wherein the regions that reflect the light is an array of rectilinear or 2D symmetric reflectors. In other embodiments, the regions that transmit light are arranged as plurality of one dimensional (1D) apertures or 2D apertures, wherein the plurality of apertures has a variable pitch between the apertures. The regions that transmit light may be an array of microlenses that transmit and focus the light.

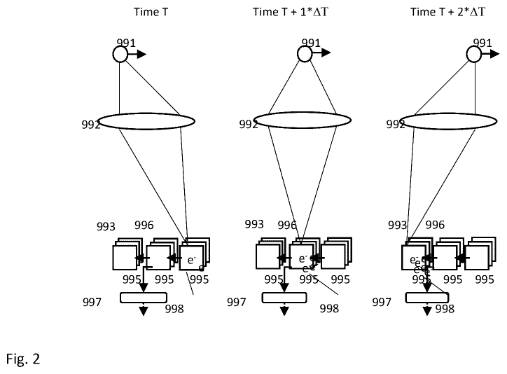

In some embodiments, the first imaging system and the second imaging system may be two TDI cameras, TDI camera 14 (out-of-focus) and TDI camera 24 (in focus) or an appropriate setup of optical components 13 such as lenses that relay the image to two TDI cameras, TDI camera 14 (reflected) and TDI camera 24 (transmitted). The TDI cameras are operated with a timing that is chosen to be consistent with the movement of the sample stage, 5. In other words, the photoinduced charge 998 in the photosensitive detector lines 995 of the TDI camera 14, 24 is shifted synchronously with the sample 991 movement such that light emitted by one point of the sample travels through the optical system 992 at best photoinduces charge in the same, synchronously shifted, potential well that is being digitized 997 after passing all photosensitive lines of the detector 993 (FIG. 2).

The figures illustrate several embodiments 10, 100, 200, and 300 of this scheme. It should be understood that these embodiments are exemplary only, and that many variations may exist using these design principles.

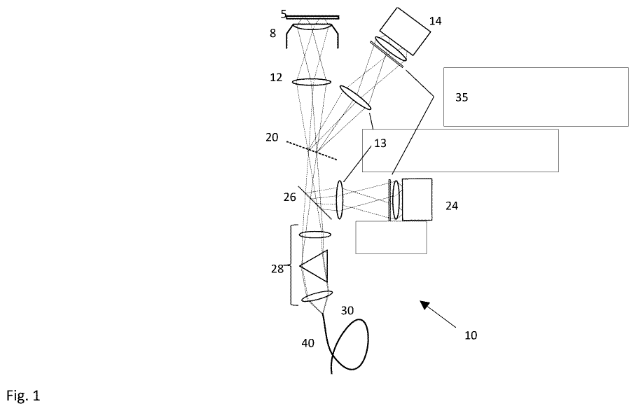

FIG. 1 illustrates a first embodiment of these concepts. In the first embodiment, the optical sectioning microscope 10 may include first an optical excitation radiation source 40. As illustrated in FIG. 1, the light source 40 may provide input radiation or input light 30 to the optical sectioning microscope 10. The light may be provided using an optical fiber, such as a round or rectangular optical fiber 40. The light source launching the radiation into the fiber may be coherent such as a laser or incoherent, such as a LED. It should be understood that other radiation sources such as uncollimated light from an arc lamp, incandescent lamp or LEDs may also be used. The homogeneous illumination may alternatively be directly provided by single units or an array of LEDs or some incoherent illumination source, such as an incandescent lamp. The purpose of the excitation radiation is to excite one or more fluorescent tags that are affixed to the biological sample mounted on the movable sample stage, after transiting the optical elements shown in FIG. 1.

Upon exiting from the light source 40, the emitted light 30 may diverge into a cone of light. In order to direct the radiation appropriately, a beam shaping structure 28 may be provided, which may collimate or focus the diverging light and re-direct the radiation. In particular, the beam shaping structure 28 may collimate and separate different wavelengths and re-direct the diverging light into generally parallel, divergent or convergent rays, which can be effectively focused, diverged or collimated by the downstream optical elements. In one embodiment, the beam shaping optics may include a pair of lenses and a wavelength separating component such as a prism, an amplitude grating, a phase grating or at least one dichroic mirror.

The wavelength separating element may be an element that refracts, transmits, diffracts or reflects light at an angle that depends upon the wavelength, such that relatively longer wavelength rays are diverted at a different angle than relatively shorter wavelength rays. These different trajectories may cause the wavelengths to propagate through the optical system differently, and as discussed in detail below, and in particular, the different wavelengths may impinge upon a different area of the mask, 20. More generally, the wavelength separating device may be a component which directs different wavelengths of light into different directions or onto different positions in the image plane or a plane conjugate to the image plane.

As a result, the trajectories for different wavelengths of light may be different through the system, from upstream to downstream. The downstream components may be designed with attention given to the specific wavelengths of light which may interact with these components, and where these interactions may occur, in view of the different trajectories. In particular, the partially reflective and partially transmissive mask 20 may have features in different regions of the mask 20 which are tailored for the specific wavelengths directed to each region of the mask. Such mask designs are discussed in detail below.

Continuing with the first exemplary embodiment 10 shown in FIG. 1, upon emission by the source 40, and after collimation, diverging or focussing by the beam shaping optics, 28, the radiation may impinge upon a dichroic mirror 26, which may have different optical properties for different wavelengths of light. In particular, the dichroic mirror may separate the light from the different fluorescent wavelength (compared to the excitation radiation), such that the different fluorescent wavelength propagates along a different path than the light.

This feature may be useful for separating incident excitation light from induced fluorescent light. From the backside, the radiation 30 may pass through the dichroic mirror 26, and through the backside of the partially transmitting, partially reflective mask, 20.

After transitting through mask 20, the radiation may be directed through the tube lens 12, and finally to the objective lens, 8. The objective lens then focuses the excitation light on to the biological sample held by the continuously moving stage, 5.

This radiation may cause appropriately tagged molecules in the biological sample to fluoresce. Alternatively, embodiments that make use of phosphorescence may be possible.

The fluorescence may then return along the same path as the excitation light. In particular, the fluorescence may travel back through the objective lens 8, back through the tube lens 12, and impinge upon the partially transmissive and partially reflective mask 20. As with the incoming radiation, the fluorescent light is focused by the objective lens and the tube lens 12 to a point adjacent the partially transparent and partially reflective mask 20.

Fluorescent light which is properly focused and aligned on the mask, 20, may fall on a transmissive portion of the mask 20, and thus be transmitted through it. After the mask 20, the light may impinge upon the dichroic mirror, 26, located behind the mask, 20. This dichroic mirror may then reflect the fluorescent light through relay optics 13 and filter 35, and then onto the in-focus TDI camera, 24. This camera, 24, then registers the in-focus light generated at the location of the sample on the moving stage, 5.

Light which is out-of-focus at the mask, 20, may instead impinge on the reflective regions around the transparent portions of the partially transmitting and partially reflective mask 20. This out-of-focus light may be light which originates from different depths within the biological sample. Thus, this arrangement can be viewed as an optical sectioning or depth discriminating imaging system that images features at different depths within the sample.

This out-of-focus light may be reflected by the reflective portions of the partially transmissive and partially reflective mask, 20. This reflected light is then directed through the relay optics 13 and filter 35 and imaged onto a second TDI camera 14, which therefore measures the reflected light, and makes an image of its intensity originating from this position on the biological sample on the moving stage, 5.

The data collected by the out-of-focus TDI camera 14 may be used algorithmically to remove out-of-focus light or background from the image by subtraction from the data collected by the in-focus TDI camera 24, to remove the contribution to the signal by structures at depths within the sample different from the image plane or focal plane of the objective lens. Accordingly, the use of the second TDI camera may improve the depth resolution, i.e. the sectioning capability, of the microscope.

The discussion now turns to the detailed handling of the data as captured by the in-focus TDI camera, 24, and the out-of-focus TDI camera, 14. It should be understood that both TDI camera 14 and TDI camera 24 operate in essentially similar ways, such that the discussion to follow applies equally to both the in-focus TDI camera 24, and the out-of-focus TDI camera, 14. Importantly, the acquisition speed of both of these cameras is related to the velocity of the movement of the sample stage 5, which is holding the biological sample and moving it. A sample stage may be any structure capable of moving the sample predictably in the x-y plane (where z is the optical axis of the objective lens). Stepper motor driven stages, motorized gear-driven x-y stages, and other actuators holding the sample are examples of some workable movable sample stages.

FIG. 2 is a simplified schematic illustration of signal generation in the TDI device 14 or 24 during the continuous line scanning. Light propagates from a light emitting particle 991, e.g. a fluorescent molecule, a fluorescently stained biomolecule such as a tagged antibody or a fluorescent nanosphere, through the optical system 992 and is focused onto the pixels 995 which are arranged in lines on the camera detector 993. As the light emitting particle moves during the acquisition, the generated photocharges in the detector are shifted row-wise to follow the movement, as indicated by 998. After passing of each time interval AT the charge in the last pixel row 996 is digitized in an analogue-to-digital converter 997. More generally, the controller is configured to operate the at least one first detector and at least one second detector based on the speed of the sample stage.

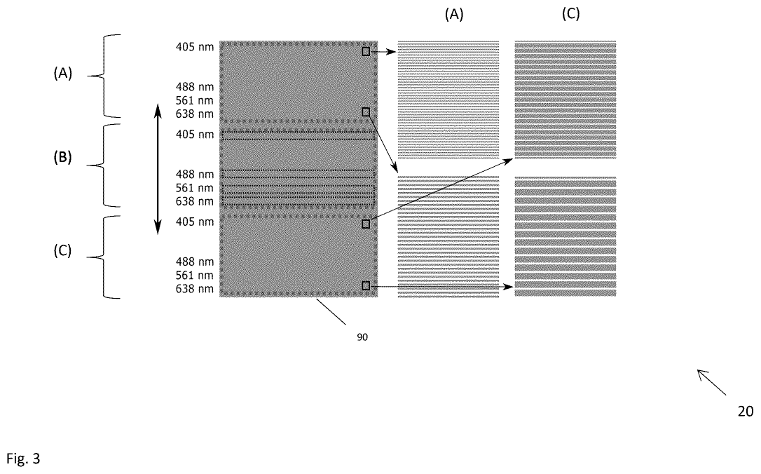

FIG. 3 shows detail of an exemplary embodiment of a partially reflective and partially transmissive mask used in the TDI-based continuous line scanning. As illustrated in FIG. 3, the mask 20 may have different regions with a variety of attributes. Some regions have features which may have dimensions chosen with respect to the radiation wavelength or fluorescence wavelength that is expected to fall on that region. For example, in FIG. 3, 90 refers to the entire mask area, which can be divided into sections (A) and (C). In each of sections (A) and (C), the dimensions of the features from top to bottom correspond to expected wavelengths going from shorter to longer. For example, the top portion of section (A) is designed for the widely used DAPI dye, commonly excited in the violet at 405 nm. The bottommost portion of section (A) has dimensions appropriate for longer wavelengths and specifically about 638 nm, which is commonly applied to excite the organic dye Cy5.

Section (C) is similar to section (A) in that the upper portion is dimensioned for shorter wavelengths and the bottom is dimensioned for longer wavelengths. The difference between (A) and (C) is that the duty cycle for section (A) is 50%, whereas for section (C) it is 25%. “Duty cycle” here means the ratio of transmissive-to-reflective area. Different duty cycles may be selected to adjust the tradeoff between optical sectioning and system sensitivity to different samples.

At the beginning of a run with the optical sectioning continuous line scanning microscope, the operator or an automated one-dimensional or two-dimensional stage may align the mask 20 until the appropriate radiation falls onto the selected area of the mask 20. In a subsequent run, a different level of optical sectioning, signal amplitude or radiation power may be selected, which may require a change of the area of the mask used.

It should be noted that this scheme can be applied to any other combination of excitation wavelength spanning the ultraviolet (UV), visible (VIS) and infrared (IR) spectrum or a combination thereof. It should be noted that this scheme can be applied to any other combination of fluorescing particles such as organic dyes, fluorescent proteins, quantum dots, labeled nanobeads, autofluorescing biomolecules or a combination thereof.

Accordingly, FIG. 3 illustrates a possible design of the mask disposed in the intermediate image plane. Other embodiments may include a convolved design to save space. Another embodiment could also use round pinholes in a square grid or hexagonal grid for the best tradeoff between sectioning and sensitivity. A one-dimensional pattern using lines is may provide improved homogeneity.

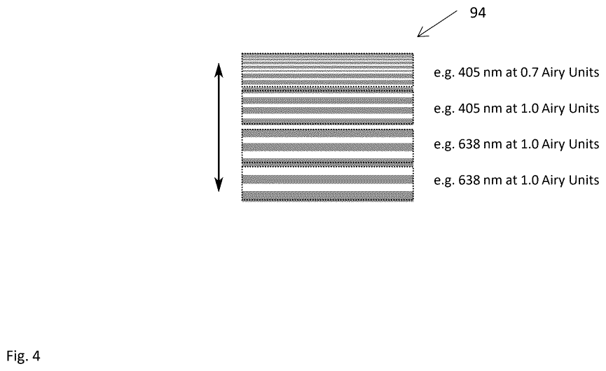

FIG. 4 shows additional detail of a portion 94 of a partially transmissive and partially reflective mask 20 with changing pitch between transmissive-to-reflective regions, appropriate for different fluorescent tags. Shown in FIG. 4 is a possible design of the mask in the intermediate image plane. The gradually increasing line width is used to vary the line widths almost continuously by shifting the mask slightly up and down.

FIG. 4 further shows greater detail of the portion 94 of a partially transmissive partially reflected mask 20 which may be used in the embodiment 10 shown and described previously. Different portions of the partially transmissive partially reflective mask may have different areas which have different patterns of partially transmissive and partially reflective regions. Because one component of the optical sectioning device described in FIG. 1 may have a wavelength separating element, each of the wavelengths of fluorescent radiation may fall on a different portion of the partially transmissive and partially reflective mask 94. Accordingly, different areas of the mask 20 may be designed for different fluorescent wavelengths corresponding to different fluorescent dyes. Consider two widely used dyes, DAPI and Cy5. DAPI is commonly excited at approximately 405 nm whereas Cy5 is commonly excited at approximately 638 nm. These dyes may produce fluorescence at slightly red-shifted wavelengths which may fall on different portions 94 of the mask 20. Thus, the pitch between the apertures may be proportional to the wavelengths of the light, such that some portions of the mask have one dimension suitable for one wavelength of light, and other portions have other dimensions based on other wavelengths of light.

Accordingly, the pitch between the transmitting/reflecting regions in different regions of the mask 20 may be chosen to be appropriate for a given wavelength.

Thus, shorter wavelengths which may correspond to the DAPI dye (approximately 405 nm) may have higher pitch (more closely spaced reflective regions) compared to longer wavelengths (approximately 638 nm) corresponding to Cy5. Accordingly, the upper regions intended for use with DAPI may have more closely spaced partially reflective and partially transmissive areas as shown in FIG. 4. In contrast, a lower portion of this mask 94 shown as 638 nm radiation may have more coarsely graded partially transmissive and partially reflective regions, which is appropriate for its longer wavelength. In other words each portion 94 of the mask 20 may be tailored for the wavelength that impinges upon it and may be designated by “Airy units”, wherein an Airy unit is defined as the diameter of the central maximum peak of the Airy pattern. Shorter wavelengths regions have a smaller Airy unit, corresponding to closer dimension areas of transmission and reflection. Longer wavelengths such as 638 nm may have more coarsely graded areas.

As described previously, features related to the Airy unit of the different wavelengths may also be portions 94 of mask 20 which provide different pitches between reflective and transmissive features, in other words there may be areas on the mask which have a larger reflective region relative to a transmissive region. In operation, an operator may set up the precise location of mask 94 to intercept 405 nm radiation which made correspond to a DAPI fluorescent tag as well as 638 nm radiation which may correspond to a Cy5 fluorescent tag. The gradually increasing line width shown in FIG. 4 may be used to vary the line widths almost continuously by shifting the mask slightly up and down. A similar scheme may be used to vary the duty cycle almost continuously but keeping the line width constant or a combination of varying duty cycle and line width.

It should be noted that only the two exemplary wavelengths 405 nm and 638 nm and fluorescent labels DAPI and Cy5 are discussed here in detail. It should be understood that these details are exemplary only, and that the concepts and techniques described here may be applied to a large number of other types of radiation and of many different wavelengths. The techniques may also be applied to two or more wavelengths and fluorescent labels simultaneously.

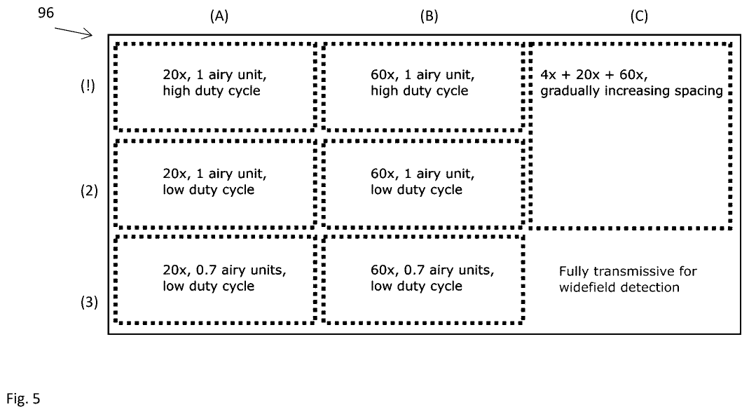

FIG. 5 shows a map layout 96 of a possible partially reflective and partially transmissive mask 20. The map may be divided into eight regions, arranged in three rows (1), (2), and (3) and three columns, (A), (B), and (C). Column (A) corresponds to a relatively low magnification (20×) of the microscope low and column (B) corresponds to a relatively high magnification (60×) of the microscope. Different magnifications may for example be selected by choosing objective lenses that provide different magnifications. Column (C) may have a range of magnifications 4×/20×/60× by having gradually increasing spacing. Row (1) may be a high duty cycle and row (2) may be a low duty cycle. Row (3) may result in better optical sectioning but lower sensitivity, as it operates at a lower Airy unit, 0.7 Airy units rather than 1.0 Airy units. The lower right hand corner (Column C; Row 3) may be left fully transmissive for widefield detection.

As before, the operator can decide which region of mask 96 is most advantageous or effective. The optical path may then be aligned to interact with the chosen area on the mask 96 or mask 96 may be laterally shifted for the selected region to become active.

It should be understood that the details of mask 20 depicted in FIG. 5 are exemplary only, and that a wide variety of other mask layouts may be envisioned.

For example, in other embodiments, a possible design of a complex mask at he intermediate image plane may be optimized for multiple different settings including optical sectioning capabilities, objective lenses and pure widefield-detection.

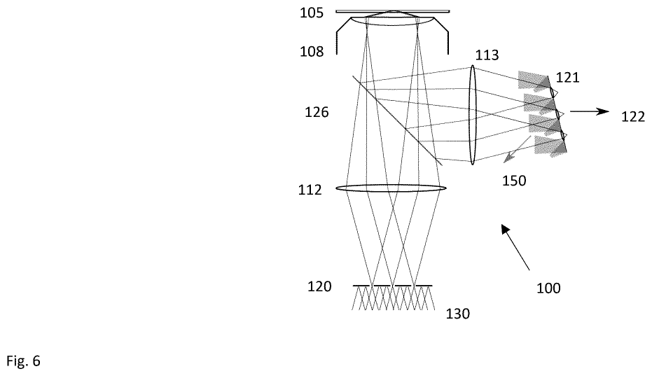

FIG. 6 shows a second embodiment 100 of a system for optical sectioning using a TDI based continuous line scanning device. The system 100 may start with homogeneous illumination 130. The homogeneous illumination 130 may for example be single units or an array of LEDs, lasers or the output of an optical fiber, or some incoherent illumination source, such as an incandescent lamp. The homogeneous illumination 130 is directed against a partially transmissive mask at an intermediate image plane 120. This image plane may be with respect to tube lens 112. In other words, the homogeneous illumination may have a focal point in the image plane of lens 112, which is approximately at the position of the partially transmissive partially reflective mask 120, or slightly upstream or downstream of that position.

Light which impinges onto the intermediate image plane, 120, and impinges on a transmissive region of the mask 120, may traverse the image plane 120. The light may then be directed via tube lens 112 and the objective lens 108 to the sample plane which is conjugate to the intermediate image plane 120. As with the previous embodiment 10, the sample mounted on the sample stage 105 is continuously moved in the focal plane of objective lens 108. Accordingly, the homogeneous illumination 130 spatially filtered via the mask 120 excites fluorescent tags affixed to the biological sample. Excited fluorophores of the tags then emit fluorescent radiation identifying the structure emitting the fluorescence. This florescence is transmitted back through objective lens 108. Past the objective lens 108, the fluorescence may be reflected by dichroic mirror 126. Dichroic mirror 126 then redirects the florescence through a second tube lens 113 and focuses it onto a microlens array 121. Microlens array 121 may also function as an partially transmissive and partially reflecting mask, with the microlenses serving as the transmissive apertures compared to mask 20 in FIG. 1. In-focus light therefore passes through the microlens array 121 and out-of-focus light is reflected by a reflective layer between the mounted microlenses.

Accordingly, light which is properly focused onto microlens array 121 may be directed onto a downstream installed TDI camera 122 which is positioned at the focus of the microlenses or downstream at a plane conjugate to the focus of the microlenses. Between the microlenses in the microlens array may be a reflective material which reflects out-of-focus light to a second TDI camera that is placed in a plane approximately conjugate to the microlens array.

Accordingly, FIG. 6 is a simplified schematic illustration of a second exemplary embodiment 100 of an optical layout of the optical sectioning microscope using TDI-based continuous line scanning, showing the optical setup for resolution enhancement via re-scan principle. For the emission beam path, the out-of-focus rejection and the rescaling via the microlens array could also be implemented at two different elements placed at conjugate planes but separated by a relay system.

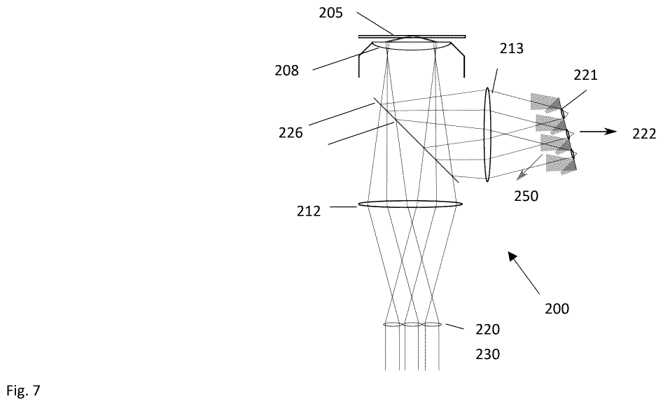

FIG. 7 shows a third exemplary embodiment 200 of a system for optical sectioning using a TDI-based continuous line scanning microscope. In the embodiment shown in FIG. 7, the illumination is again provided by a homogeneous source, 230. The homogeneous illumination 230 maybe for example be single units or an array of LEDs or lasers or the output of an optical fiber, or some incoherent illumination source, such as an incandescent lamp. The homogeneous illumination 230 may be directed to a microlens array 220. The microlens array 220 may focus the homogeneous illumination 230 to an array or a line of points upstream and in the image plane of tube lens 212. Accordingly, the homogeneous illumination 230 may come to a focus prior to the tube lens 212 and diverge from that focus to be re-collimated by tube lens 212.

From the tube lens 212, the radiation me be directed through the backside of a dichroic mirror, 226. Objective lens 208 focuses the radiation onto the sample held by the continuously scanning stage 205. The radiation 230 excites fluorescent tags on the biological sample. As in the previous embodiment, the biological sample is mounted on a moving stage which continually moves the position of the biological sample with respect to the objective lens 208. The fluorescent tags affixed to the biological sample fluoresce as a result of the excitation illumination 230. The fluorescence passes objective lens 208, traveling back to the dichroic mirror 226. The dichroic mirror than redirects the fluorescent light through another tube lens 214, which may focus the light onto or close to a microlens array 221.

Microlens array 221, may also function as a partially transmissive and partially reflecting mask as follows. Light which impinges on the transparent lens portion of the microlens array 221 proceeds to the in-focus TDI camera 222. Between the microlenses in the microlens array 221, there may be reflective areas. These reflective areas may reflect the fluorescent radiation onto the out-of-focus TDI camera 250.

The control of the TDI cameras 222, 250 is similar to the control of TDI camera 14, 24, 122 and 150, described previously with respect to the other embodiments.

Accordingly, FIG. 7 is a simplified schematic illustration of a third exemplary embodiment 200 of an optical layout of the optical sectioning microscope using TDI-based continuous line scanning. This embodiment uses another version of the optical setup for resolution enhancement via re-scan principle and more efficient light use via a microlens array in the excitation beam path.

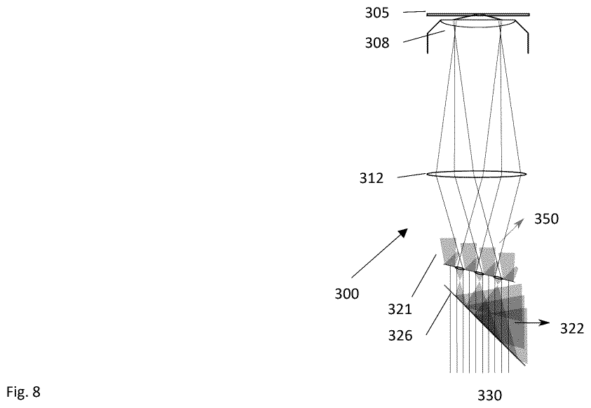

A fourth exemplary embodiment 300 is shown schematically in FIG. 8. In FIG. 8, homogeneous illumination 330 is provided as before. This homogeneous illumination 330 may pass through the backside of dichroic mirror 326, and then through a microlens array 321 positioned approximately at the intermediate image plane that is conjugate to the image plane of the objective lens 305. Light which impinges on the lenses of the microlens array 321 is brought to a focus at the point shown, from which travels to tube lens 312. The illumination then proceeds through tube lens 312 to come to a focus at the image plane of objective lens 308. The light is focused by objective lens 308 onto the sample which is held by the continuously scanning stage 305. The excitation radiation is absorbed by the fluorescent tags which fluoresces at different wavelength as a result. The fluorescent radiation coming from the biological sample held on the scanning stage 305 then passes objective lens 308, and travels back through tube lens 312.

Tube lens 312 focuses the fluorescent radiation as before. Radiation which is properly focused impinges on the lens portions of the microlens array 321. The transmitted light is additionally focused by the microlenses. The in-focus fluorescence radiation is then reflected off dichroic mirror 326 and passed to in-focus TDI camera 322 which detects in-focus radiation and is positioned at a plane conjugate to the intermediate image plane formed by tube lens 312 and microlens array 321. Out-of-focus radiation which impinges instead on reflective regions of the microlens array 321, is directed to an out-of-focus second TDI camera 350 which is positioned a a plane conjugate to the intermediate image plane formed by tube lens 312.

Accordingly, FIG. 8 is a simplified schematic illustration of a fourth exemplary embodiment 300 of an optical layout of the optical sectioning microscope using TDI-based continuous line scanning. In this embodiment, the optical setup for resolution enhancement via re-scan principle and more efficient light uses a microlens array shared by the emission and excitation beam paths.

The partially transmissive and partially reflective masks and arrays, in these embodiments, may be disposed in a plane, but other configurations are possible and envisioned, for example, in convex or concave shapes to accommodate a non-linear or astigmatic focus.

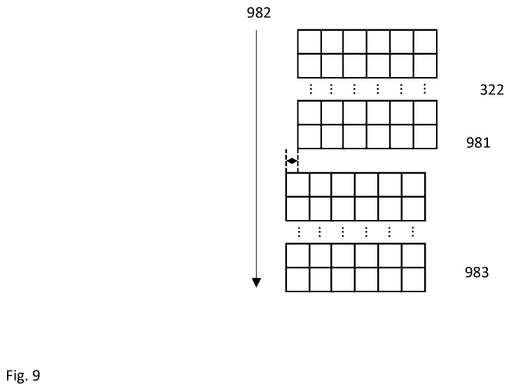

FIG. 9 shows the setup of an envisioned TDI camera featuring of two adjacent detectors 983 and 983′ which are shifted by ½ pixel width 981 orthogonal to the stage movement direction 982, which can be used for computational resolution enhancement orthogonal to the stage movement direction 982.

In an envisioned embodiment where an array of cylindrical microlenses may be used in place of the mask 20. In this embodiment, the array of cylindrical microlenses is placed in the intermediate image plane which may be used for resolution enhancement via re-scan principle along the stage movement direction only, the combination with the aforementioned TDI camera featuring two adjacent detectors shifted by ½ pixel orthogonal to the stage movement direction may provide an isotropic or nearly isotropic two-dimensional resolution enhancement by applying established processing of the camera data.

In these embodiments 10, 100, 200, 300 the combination of at least one tube lens 12, 112, 113, 212, 214, 312 with an infinity corrected objective lens 8, 108, 208, 308 is used to relay a magnified or non-magnified version of the image in at least one plane approximately at a mask 20, 120, 121, 220, to the conjugate plane where the sample is in focus of the detection optics.

It must be understood that instead of using the combination of a tube lens with an infinity corrected objective lens, a directly focusing objective lens may be used omitting the use of a tube lens.

Accordingly, disclosed here is a microscope for imaging a sample. The microscope may have an intermediate image plane that is conjugate to the image plane. The microscope may include an optical system with a light source emitting light, wherein the light is directed by the optical system to the sample through the intermediate image plane, and at least one mask disposed adjacent to a plane conjugate to the image plane, wherein the at least one mask comprises regions that transmit-the light and regions that reflect-the light. The microscope may further have at least one first detector that detects light from the sample transmitted through the at least one mask, and at least one second detector that detects light from the sample reflected by the at least one mask. The microscope may also have a moving stage configured to continuously move the sample during detection by the first and second detectors, and an image processing controller, programmed to form a corrected image based on both the transmitted and the reflected light from the continuously moving sample.

The at least one detector may comprise at least one TDI camera. The regions that transmits light may be an array of apertures in the mask that transmit the light and wherein the regions that reflect the light may be an array of reflectors.

In some embodiments, the regions that transmit light may be an array of rectilinear apertures or 2D symmetric apertures, wherein the apertures may comprise slots, slits or pinholes in the mask that transmit the light and wherein the regions that reflect the light is an array of rectilinear or 2D symmetric reflectors. In other embodiments, the regions that transmit light are arranged as plurality of 1D apertures or 2D apertures, wherein the plurality of apertures has a variable pitch between the apertures. The regions that transmit light may be an array of microlenses that transmit and focus the light.

The pitch between the apertures may be proportional to the wavelengths of the light, such that some portions of the mask have one dimension suitable for one wavelength of light, and other portions have other dimensions based on other wavelengths of light. The at least one light source may generate light having multiple different wavelengths. Further, the microscope may further comprise a wavelength dispersive or wavelength splitting or a grating element, which redirects some wavelengths of the multiple different wavelengths of the light into different trajectories than other wavelengths of the light. In other embodiments, the microscope may further comprise a dichroic mirror that separates the light from the different fluorescent wavelength, such that the different fluorescent wavelength propagates along a different path than the light. The sample may be is at least 1 um thick and may comprises a tissue section.

The controller may operate the at least one first detector and at least one second detector based on the speed of the sample stage. In the microscope, The sample may include fluorescent tags which fluoresce at a different wavelength from the light source. The controller may also perform an algorithmic manipulation of the data to improve an attribute of the image, wherein the algorithm comprises either a weighted or non-weighted subtraction of data from the image. The algorithmic manipulation may comprise a weighted or non-weighted subtraction of the out-of-focus data from the in-focus data.

The sample is configured for at least one of spatial proteomics, spatial transcriptomics and spatial genomics.

It should be understood that the drawings are not necessarily to scale, and that like numbers maybe may refer to like features.

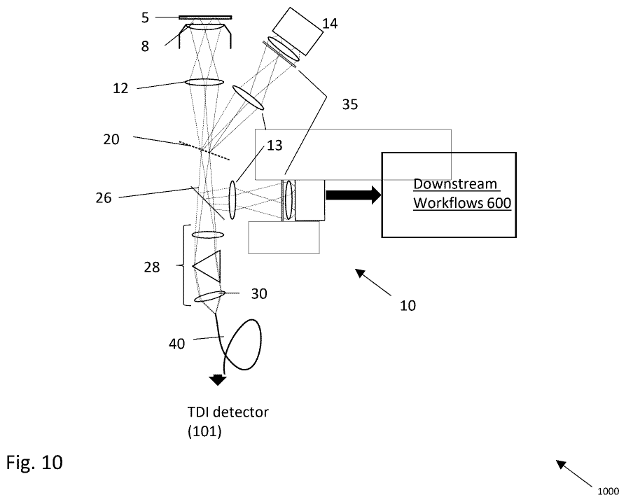

FIGS. 10-13 illustrate the application of this imaging system 10 to a generic downstream workflow 600. Many different sorts of downstream workflows are envisioned, including centrifugation, incubation, staining, chemical and microscopic analysis. One embodiment is discussed in detail below, which is a DNA analysis protocol.

The optical sectioning microscope can be used for imaging fluorescently labeled samples (5) such as adherent cells, viruses, bacteria, co-cultures, tissue sections, whole organs, or organoids.

To image multiple different targets in a sample, e.g. biomolecules such as proteins, nucleic acids, lipids, cellular organelles, receptors, such targets may be stained with different fluorophores.

Samples (5) may be chemically fixed before being put on the microscope or being put live on the microscope (10).

For imaging of live samples, the sample may be embedded in a device to keep the sample alive such as an incubator which includes the whole microscope or which is directly attached to the microscope stage.

Adherent cells, such as immortalized cell lines, may be grown at 0 to 100% confluency on coverslips, slides, petri dishes or other biocompatible vessels.

Co-cultures can be at least two types of different adherent cells, viruses, bacteria or other biological targets or a combination thereof simultaneously being imaged.

Imaging of co-cultures is typically performed to investigate the interaction between at least two different biological targets.

Tissue sections may be samples taken from human or animal organs.

Possible preparation techniques for tissue sections include cryo sectioning or paraffin embedding.

Whole organs may be taken from humans or animals and prepared e.g. using established fixation and/or optical clearing techniques before being fluorescently labeled and applied to the microscope.

Organoids may be artificially prepared, multicellular microstructures e.g. to mimic physiologically relevant human or animal organs.

Fast stage scanning of the whole sample is beneficial for achieving high throughput or scanning the whole sample or parts of the sample multiple times at high frequency to achieve live imaging at high temporal resolution.

High throughput may be desired when multiple targets such as proteins, nucleic acids, lipids, organelles, receptors, or any combination thereof in the same sample shall be visualized, e.g. in a cycling imaging approach.

A possible implementation of a cyclic imaging approach includes in each of multiple cycles the targeted staining of a subset of the multiple targets e.g. including immunostaining followed by their imaging followed by the erase of the staining (i.e. de-staining) in the particular cycle.

Multiple targets may be visualized simultaneously, e.g. using any of the spatial wavelengths separation approaches shown in FIGS. 1, 6, 7 and 8 and/or subsequently inserting an emission filter changer (35) before the detector (24).

An emission filter changer may be a wheel, a slider, or any other device that holds at least one emission filter to spectrally filter the light emitted from the sample which passes to the detector. Such at least one emission filter can actively be moved into the optical path by the emission filter changer.

When using an emission filter changer (35) before the detector (24), the one filter or multiple emission filters (36) can be selected according to the emission wavelength of the target fluorophore.

An alternative approach to visualize multiple targets simultaneously is to use a light source (40) that can emit different wavelengths and at least two different wavelength can be individually switched on or off. The sample can be scanned multiple times, each time switching one or a different combination of individual wavelengths on and exciting different fluorescently labeled targets in the sample by spectral targeting.

Spectral targeting is possible as a set of different fluorophores for staining the sample can be selected carefully according to their excitation spectrum. Hence, each target can be excited at a different peak wavelength.

Efficient targeting is possible by a combination of simultaneous and subsequent imaging of different fluorophores and/or targeting the emission by selecting the corresponding one emission filter or emission filters, respectively, and/or targetting the excitation by selecting the corresponding excitation wavelengths or a combination thereof.

After selecting wavelengths and appropriate filters, the novel imaging system 10, described above may be coupled to a genetic sequencer, simply referred to as sequencer 600, or other cellular or genetic manipulation, and thereby obtain detailed information relating to a singular, specific biological particle, cell, tissue section, whole organ sample, organoids or any of the above mentioned.

The system 1000 is shown in FIG. 10, with the workflow 600 coupled to the imaging device 10, to create the imaging device and sequencer 1000. In addition, an identifying label or barcode may be affixed to the particle, such that the genomic sequence is associated with a single, identified, particular biological particle.

This whole imaging system and sequencer 1000 may operate generally as follows:
1) Put a sample and chemistry including the barcode information into buffer fluid or droplet
2) Image the sample
2) Lyse tissue sample to set DNA and RNA free
3) Fragment the DNA/RNA, optionally followed by some further chemistry. Label fragments of DNA/RNA with barcode information
4) Sequence fragments and via barcode to find out what specific cell had what genetic information. Sequencing may make use of a genetic library, depending on the sequencing technique. These steps and techniques are described in further detail with respect to the embodiment discussed below. The details of these steps can also be found in the following documents, all of which are incorporated by reference in their entireties. Although the system 1000 is described with respect to optical sectioning system 10, it should be understood that other embodiments may also be used, including those illustrated in FIGS. 6, 7 and 8, and designated by 100, 200 and 300.

1) “Methods and Systems for Associating Physical and Genetic Properties of Biological Particles” PCT/US2018/061629, 16 Nov. 2018 (WO2020207963)

2) “Conjugates Having An Enzymatically Releasable Detection Moiety And a Barcode Moiety” (PCT/EP2020/059747, filed Apr. 6, 2020 (WO 2019099908)

3) “COLOR AND BARDCODED BEADS FOR SINGLE CELL INDEXING” 12 Nov. 2020, PCT/EP2020/081851

4) EP20182775.5 “METHOD COMBINING SINGLE CELL GENE EXPRESSION MAPPING AND TARGETED RNA OR c-DNA SEQUENCING USING PADLOCK OLIGONUCLEOTIDES COMPRISING A BARCODE REGION” June 29 2020, EP20182775.5

What follows is an embodiment of the system and method outlined generally above. In the following description, certain terms of art may be used. While these terms are widely known to those skilled in the art, to avoid confusion the following definitions are offered:

Genomics: A part of molecular biology looking at the structure, function, evolution and mapping of genomes of any living organism. It includes the study of the set of DNA and/or genes.

Transcriptomics: The study of a set of RNA molecules in cells and/or tissue. Proteomics: Studying the set of proteins in cells and/or tissue.

cDNA is complementary DNA, which is DNA synthesized from a single-stranded RNA (e.g., messenger RNA (mRNA) or microRNA (miRNA)) template in a reaction catalyzed by the enzyme reverse transcriptase.

Barcoded primers are single ended oligonucleotides that contain predefined sequences. These sequences can later on be decoded again and can be used as a unique identifier for each detected cell in the process. In the present application barcoded primers contain oligo(dT) which will interact with the poly A tail of the mRNA, a unique barcode and molecular identifier (UMI).

RT reagents are all reagents used to do reverse transcription of RNA to cDNA. Usually RT reagents contain an enzyme such as reverse transcriptase, random hexamers, oligo(dT) and sequence specific reverse primers.

Reaction vesicles are the reactors where the reaction takes place. In this application reaction vesicles are the water in oil droplet with the bead and cell.

NGS stands for next generation sequencing and allows the determination of sequences in a massively parallel manner.

RCA stands for rolling circle amplification. It is a method of isothermal amplification of circular DNA molecules.

Rolonies are the product of the RCA process.

Poly A-tailed means the polyadenylation of a RNA transcript. Poly A-tail sequences only contain adenine bases.

Adaptor oligos are used during library preparation for sequencing. Adapter oligos allow to fish out short target DNA sequences of interest.

SPRI beads stands for solid phase reversible immobilization beads. Those beads are may be magnetic with a carboxyl group coating and are able to bind DNA. SPRI beads can therefore be used to do size selection.

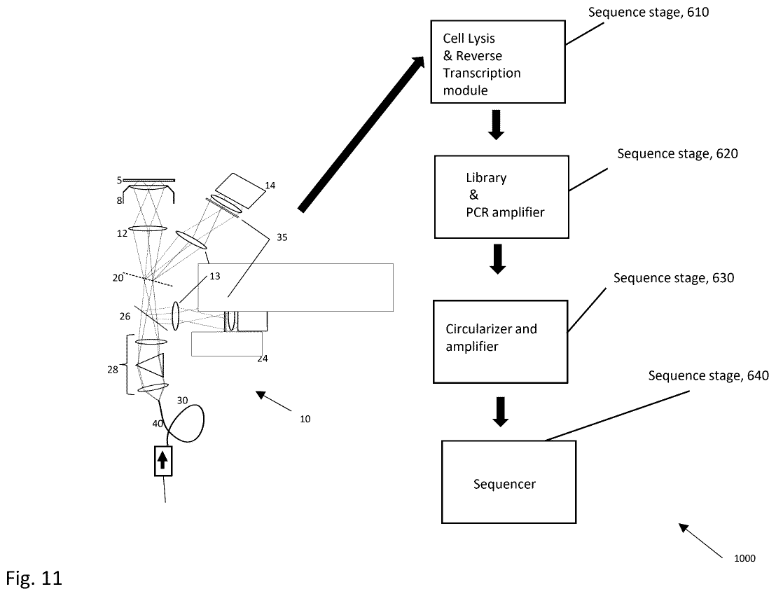

In FIG. 11, the sequencer is further depicted as including a number of modules 610-640. It should be understood that not all of these modules may be necessary to practice this invention, but that FIG. 11 is merely illustrative of a sequencing embodiment. First, each sample may further include a barcoded bead 610.

Each sample may also contain many barcoded primers. Each bead may provide primers that contain oligo(dT) which will interact with the poly A tail of the mRNA, a unique barcode and molecular identifier (UMI) that are used to index the 3′ end of cDNA molecules during reverse transcription, thus enabling the assignment of every individual transcripts and individual cells and finally the primers provide by the beads contain a PCR handle for further amplification of the library construct.

The sequencer 600 may further include a lysis & RT stage 610.

Each functional sample may contain on or more beads, each bead with primers as described in 610, and RT reagents. Within each reaction vesicle, a single sample may be lysed and reverse transcription of polyadenylated mRNA may occur. As a result, all cDNAs from a single cell will have the same barcode, allowing the sequencing reads to be mapped back to their original single cells of origin. After that step the droplets are pooled together and a alcohol based reagent is added to dissolve the oil water droplet solution. A washing step is introduced to get rid of unwanted left overs. The preparation of NGS libraries from these barcoded cDNAs is then carried out in a highly efficient bulk reaction.

The sequencer 600 may further include a library preparation stage, 620: The barcoded double stranded cDNA may be used to prepare an NGS library using conventional and prior art approach. The cDNA is fragmented enzymatically and post fragmentation, the ends are repaired and poly A-tailed. Adaptor oligos are then ligated to each extremity clean up with SPRI beads and amplified by PCR.

The sequencer 600 may further include a circularization and amplification, stage 630. The cDNA library containing adaptors and is then used as a template for rolling circle amplification (RCA). The RCA reaction needs to be primed using an oligonucleotide (RCA primers) that is complementary to the common adapter portion of the circularized DNA library. This short duplex/circular template is recognized by the Polymerase performing the RCA which amplifies the DNA regardless of the target sequence into DNA rolonies containing several hundred copies or concatemers of the DNA.

The sequencer 600 may further include a sequencing stage, 640: The rolonies are then loaded in to a micro fluidics channel. The rolonies will randomly immobilize on a functionalized glass surface. Multiple different chemistry reagents are sequentially applied to sequence the bases on each rolony. The bases are labeled with fluorescence dyes which an optical imaging system can detect during each cycle of sequencing. A sophisticated algorithm takes all those raw images coming from the optical imaging system and does the base calling for each rolony and determines the bases.

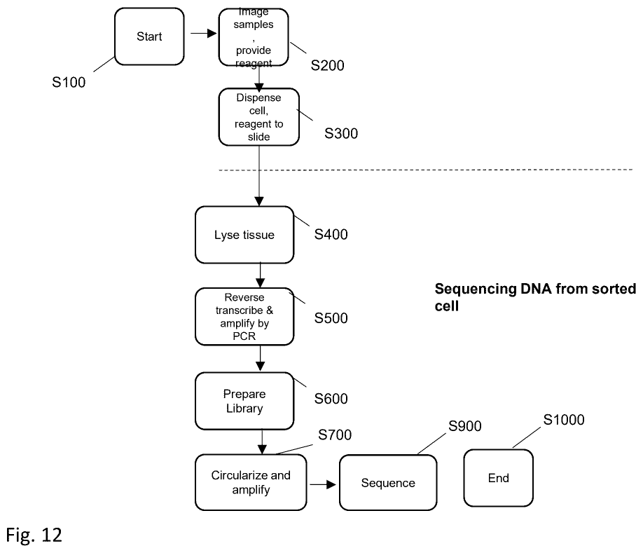

A process or method to sequence the genetic material of a biological sample after being imaged by imaging system 10 is also disclosed here, and this method is illustrated in FIG. 12. The method may begin in step S100. In step S200 the cells or biological sample is imaged. In step S300, the prepared cells or sample may be dispensed into a buffer fluid and the buffer fluid may form a droplet inserted into a flowing stream, surrounded by an immiscible fluid. In step S400, the droplet is destroyed, and the tissue is lysed to release the genetic material encapsulated therein. In step S500, the genetic material is reverse transcribed and amplified by polymerase chain reaction. In step S600 the cDNA library is prepared. In step S700, the genetic material is circularized and amplified in an RCA. In step S900, the sequence is ascertained by successive application of a fluorescent reagent, and imaging of the sample.

It should be understand that not all of these step need necessarily be performed, and they may not need to be performed in the precise order given in FIG. 11-13. Furthermore, each of these steps may include a number of sub-steps. For example, in step S900 “sequence”, the sample of genetic material may first be introduced into a microchannel and then immobilized on a functionalized glass surface.

The imaging system can be used in a multiomics application combining workflows of genomics and transcriptomics, genomics and proteomics, transcriptomics and proteomics, or transcriptomics, proteomics and genomics. When applied to tissue samples, organs, or organoids, biological information derived from the images can be put into spatial context and analyzed therein. Accordingly, disclosed here is an optical imaging system having a focal plane and optical elements, for imaging a biological sample.

Accordingly, disclosed here is a microscope for imaging a sample. The microscope may have an intermediate image plane that is conjugate to the image plane. The microscope may include an optical system with a light source emitting light, wherein the light is directed by the optical system to the sample through the intermediate image plane, and at least one mask disposed adjacent to a plane conjugate to the image plane, wherein the at least one mask comprises regions that transmit the light and regions that reflect the light. The microscope may further have at least one first detector that detects light from the sample transmitted through the at least one mask, and at least one second detector that detects light from the sample reflected by the at least one mask. The microscope may also have a moving stage configured to continuously move the sample during detection by the first and second detectors, and an image processing controller, programmed to form a corrected image based on both the transmitted and the reflected light from the continuously moving sample.

The at least one detector may comprise at least one TDI camera.

The regions that transmits light may be an array of apertures in the mask that transmit the light and wherein the regions that reflect the light may be an array of reflectors. In some embodiments, the regions that transmit light may be an array of rectilinear apertures or 2D symmetric apertures, wherein the apertures may comprise slots, slits or pinholes in the mask that transmit the light and wherein the regions that reflect the light is an array of rectilinear or 2D symmetric reflectors. In other embodiments, the regions that transmit light are arranged as plurality of 1D apertures or 2D apertures, wherein the plurality of apertures has a variable pitch between the apertures. The regions that transmit light may be an array of microlenses that transmit and focus the light. The pitch between the apertures may be proportional to the wavelengths of the light, such that some portions of the mask have one dimension suitable for one wavelength of light, and other portions have other dimensions based on other wavelengths of light. The at least one light source may generate light having multiple different wavelengths.

Further, the microscope may further comprise a wavelength dispersive or wavelength splitting or a grating element, which redirects some wavelengths of the multiple different wavelengths of the light into different trajectories than other wavelengths of the light. In other embodiments, the microscope may further comprise a dichroic mirror that separates the light from the different fluorescent wavelength, such that the different fluorescent wavelength propagates along a different path than the light. The sample may be is at least 1 μm thick and may comprises a tissue section.

The controller may operate the at least one first detector and at least one second detector based on the speed of the sample stage. In the microscope, The sample may include fluorescent tags which fluoresce at a different wavelength from the light source. The controller may also perform an algorithmic manipulation of the data to improve an attribute of the image, wherein the algorithm comprises either a weighted or non-weighted subtraction of data from the image. The algorithmic manipulation may comprise a weighted or non-weighted subtraction of the out-of-focus data from the in-focus data. The sample is configured for at least one of spatial proteomics, spatial transcriptomics and spatial genomics.

A DNA sequencing system may use the optical imaging system described here. A RNA sequencing system may use the optical imaging system described here. A system for performing spatial transcriptomics may use the optical imaging system described here. A system for performing spatial genomics, may use the optical imaging system described here.

A system for performing spatial proteomics may use the optical imaging system described here. A system for imaging of cell monolayer, may use the optical imaging system described here. A system for performing imaging of cell co-cultures, may use the optical imaging system described here. A system for performing imaging of tissue sections, may use the optical imaging system described here.

Accordingly, disclosed here is an optical imaging system having a focal plane and optical elements, for imaging a biological sample. The systema may include a stage holding the sample wherein the stage is configured to continuously move the sample in at least one direction parallel to the focal plane, and at least one non-point-like light source emitting at least one wavelength. The system may further include at least one non-point-like light source disposed adjacent to a plane conjugate to the focal plane of the microscope, and a detector which forms an image of the sample on the moving sample stage.

The detector may have at least one row of pixels to which the image of the sample moves perpendicular during the imaging process. The detector may be a time delayed interval (TDI) detector.

The at least one non-point-like light source may emit a plurality of wavelengths, and the non-point-like light source may be at least one of a laser, an array of lasers, an optical fiber, an array of optical fibers, a laser diode, an array of laser diodes, an LED, an array of LEDs, an incandescent lamp, an array of incandescent lamps, a gas-discharge lamp, and an array of gas-discharge lamps. The at least one non-point-like light source may be anamorphotically imaged onto a sample plane containing the biological sample.

The system may further include a wavelength separating element. he wavelength separating element may separates wavelengths by diffraction, refraction, transmission or reflection. The wavelength separating element may be at least one of a prism, a wavelength dependent turning mirror and a diffraction grating. The wavelength separating structure may include an adjacent angled mirror with a plurality of surfaces, wherein at least one surface is dichroic. The optical elements may include at least one optical element chosen from the group consisting of a light amplitude modulating element, a light phase modulating element, a light refracting element, and wherein at least one optical element is disposed in an intermediate image plane of the optical imaging system. In some embodiments, beam shaping optics may include a pair of lenses and a wavelength separating component such as a prism, an amplitude grating, a phase grating or at least one dichroic mirror. The intermediate image plane may also in image plane of the detector.

A DNA sequencing system may use the optical imaging system described here. A RNA sequencing system may use the optical imaging system described here. A system for performing spatial transcriptomics may use the optical imaging system described here. A system for performing spatial genomics, may use the optical imaging system described here.

A system for performing spatial proteomics may use the optical imaging system described here. A system for imaging of cell monolayer, may use the optical imaging system described here. A system for performing imaging of cell co-cultures, may use the optical imaging system described here. A system for performing imaging of tissue sections, may use the optical imaging system described here.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1. A microscope for imaging a sample having an intermediate image plane that is conjugate to the image plane, comprising
an optical system with a light source emitting light, wherein the light is directed by the optical system to the sample through the intermediate image plane;
at least one mask disposed adjacent to a plane conjugate to the image plane, wherein the at least one mask comprises regions that transmit the light and regions that reflect the light;
at least one first detector that detects light from the sample transmitted through the at least one mask;
at least one second detector that detects light from the sample reflected by the at least one mask;
a moving stage configured to continuously move the sample during detection by the first and second detectors; and
an image processing controller, programmed to form a corrected image based on both the transmitted and the reflected light from the continuously moving sample.

2. The microscope of claim 1, wherein the at least one detector comprises at least one TDI camera.

3. The microscope of claim 1, wherein the regions that transmit light is an array of apertures in the mask that transmit the light and wherein the regions that reflect the light is an array of reflectors.

4. The microscope of claim 1, wherein the regions that transmit light is an array of rectilinear apertures or 2D symmetric apertures, wherein the apertures comprise slots, slits or pinholes in the mask that transmit the light and wherein the regions that reflect the light is an array of rectilinear or 2D symmetric reflectors.

5. The microscope of claim 1, wherein the regions that transmit light are arranged as plurality of 1D apertures or 2D apertures, wherein the plurality of apertures has a variable pitch between the apertures.

6. The microscope of claim 5, wherein the pitch between the apertures is proportional to the wavelengths of the light, such that some portions of the mask have one dimension suitable for one wavelength of light, and other portions have other dimensions based on other wavelengths of light.

7. The microscope of claim 1, wherein the regions that transmit light is an array of microlenses that transmit and focus the light.

8. The microscope of claim 1, wherein the at least one light source generates light having multiple different wavelengths.

9. The microscope of claim 8, further comprising a wavelength dispersive or wavelength splitting or a grating element, which redirects some wavelengths of the multiple different wavelengths of the light into different trajectories than other wavelengths of the light.

10. The microscope of claim 1, wherein the controller is configured to operate the at least one first detector and at least one second detector based on the speed of the sample stage.

11. The microscope of claim 1, wherein the sample includes fluorescent tags which fluoresce at a different fluorescent wavelength from the light source.

12. The microscope of claim 11, further comprising a dichroic mirror that separates the light from the different fluorescent wavelength, such that the different fluorescent wavelength propagates along a different path than the light.

13. The microscope of claim 1, wherein the controller performs an algorithmic manipulation of the data to improve an attribute of the image, wherein the algorithm comprises either a weighted or non-weighted subtraction of data from the image.

14. The microscope of claim 13, wherein the algorithmic manipulation comprises a weighted or non-weighted subtraction of the out-of-focus data from the in-focus data.

15. The microscope of claim 11, where the sample is configured for at least one of spatial proteomics, spatial transcriptomics and spatial genomics.

16. The microscope of claim 1, where the sample is at least 1 μm thick.

17. The microscope of claim 16, where the sample comprises a tissue section.
